(19) United States
(12) Patent Application Publication
(10) Pub. No.: US 2015/0305966 A1
(43) Pub. Date: Oct. 29, 2015

(54) Three-In-One Therapeutic System With Fully Magnetic, Plastic, & Combined Magnetic/Plastic Stationary Spheres

(71) Applicant: LLewellyn George, Fayetteville, GA (US)

(72) Inventor: LLewellyn George, Fayetteville, GA (US)

(21) Appl. No.: 14/259,793

(22) Filed: Apr. 23, 2014

(51) Int. Cl. A61H 15/00

(52) U.S. Cl. CPC A61H 15/00

(57) ABSTRACT

Disclosed is a device rendering magnetic healing therapy, reflexology, and massage treatment in one System. The System comprises a generally planar platform having a symmetrical pattern of plastic and/or magnetic balls embedded in the upper surface of the platform. The platform consists of a semi-rigid elastomeric material and may comprise any geometric planar profile, including a rectangle, square, triangle, circle, or other shape. The preferred embodiment of the concept comprises a rectangular platform with twenty-four (24) recessed cavities for the permanent retention of twenty-four non-rotating balls. The platform is held in the hand of a user, or a caregiver, and resistively pulled or pushed with varied degrees of pressure over the skin proximate a specific part of the anatomy most in need of therapy or stimulation.

### CROSS-REFERENCES TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the Invention

The present invention relates to the use of hand-held massaging devices used for therapeutic health care, particularly for stimulating blood circulation in a person's body. Physicians, chiropractors, and other health care professionals have been aware of the benefits of deep tissue massage for muscle rehabilitation.

Studies done by professionals in the field of therapeutic and rehabilitative treatment have shown that reflexology decreases the level of pain experienced by a person suffering from injury or disease, enhances blood circulation, and improves mental health. Reflexology therapy assists in localized pain relief and general discomfort that may exist throughout a person's body. The inventive concept herein is a Three-In-One Therapeutic System, referred to in this document as the “System.” The System comprises a generally planar platform embedded with symmetrically-spaced balls fixed rigidly into the top surface of the platform such that the balls are non-rotating. The System may be moved with varying degrees of pressure over the skin proximate the ailing part of a person's anatomy, thereby producing beneficial effects similar to that produced by the disciplines of reflexology and acupressure.

(2) Description of the Related Art, Including Information Disclosed Under 37 CFR 1.97 and 1.98.

U.S. Pat. No. 6,315,742 BI (Nov. 13, 2001; Howard). Disclosed is a massaging device adapted for effective back massage especially along the spine. A flat platform supports a number of rotating wheels positioned for contact with separated muscle groups and acupressure points. The wheels are of a rubber material of such hardness as to allow a person to lay down onto the device without pain but to receive an effective pressure massage in the tissues of the back without bruising. With the device centered on the spine and with its wheels spaced on either side of the spine the individual may move along the ground while receiving a deep therapeutic massage. A pair of close spaced rollers are positioned relative to the wheels for massaging the tissues of the neck.

US #2008/0161735 A1 (Nov. 3, 2008; Lee et al.). The invention is a microneedle roller including a plurality of discs, each of which comprises a first side surface, a second side surface and a center hole. The first side surface comprises a plurality of radial grooves, and the discs are stacked on one another in a way that the first side surface of one disc contacts the second side surface of the adjacent disc. The microneedle roller further includes a plurality of microneedles that are received in the radial grooves of the disc, and each of which has a pointed end. The pointed end protrudes beyond the outer circumference of the disc. The microneedle comprises an elongated cylindrical needle shank, a first sloped portion that starts from the pointed end, and a second sloped portion that is provided between the first sloped portion and the second sloped portion. The angle of the first sloped portion is greater.

US #2006/0276732 A1 (Dec. 7, 2006, Chen). Disclosed is a roller massager having a handle and two rollers mounted on two sides of the handle. When pushing/pulling the massager, the rollers roll on human body to provide a massaging effect. When in use, the axis of the rollers and the length of the handle contain an angle which is not right angle. In use of the roller massager, the rollers can inward squeeze the muscle of a user to achieve a kneading and massaging effect.

U.S. Pat. No. 5,913,839 (Jun. 22, 1999; Wincek). A ball-massaging board (14) molded out of plastic with a curved surface to comfortably support a person's spine in the supine position. Attached to the surface of board (14) are a number of rubber balls (15/16) that have a bolt head (18) bonded inside them, and a threaded portion (19) protruding outside them. Threaded portion (19) is inserted through a hole (21) in board (14), then secured in place by a lock nut (20). Because hole (21) is larger in diameter than the diameter of threaded portion (19) balls (15/16) are able to freely spin about the surface of board (14). Balls (15/16) are able to spin and roll simultaneously along the surface of board (14) while remaining attached to board (14). As an individual lies on the massaging board (14) and swivels his or her hips a combined spinning and rolling effect is created by balls (15/16) on the user's back and neck, simulating a real life massage. The user experiences deep penetrating massage therapy by lying on the entire diameter of balls (15/16) which effectively relieve trigger points throughout the entire back, shoulders, and neck, while rehabilitating various muscles.

### BRIEF SUMMARY OF THE INVENTION

Applying gentle or intense pressure is beneficial in releasing chronic muscle tension and invigorating the blood flow of the human anatomy. The disclosed device combines massage, reflexology, acupressure, and magnetic therapy to obtain beneficial results. The device is intended to be applied to layers of muscle tissue, tendons and fascia (the protective layer surrounding muscles, bones and joints).

The inventive concept herein comprises a solid, generally planar platform having an upper surface, an undersurface, and a continuous side (or sides) which connects both the upper and undersurfaces. The upper surface of the platform features a pattern of symmetrically-spaced hemispherical-shaped cavities. Spherical plastic balls and magnetic balls, each type of ball approximately corresponding in diameter to the hemispherical cavities, are forcibly inserted into the cavities. The platform consists of a semi-rigid elastomeric material and may comprise any geometric planar profile, including a rectangle, square, triangle, circle, or other shape.

The preferred embodiment of the concept comprises a rectangular platform with twenty-four (24) recessed cavities for the permanent retention of twenty-four non-rotating balls. The balls may be of either plastic or magnetic composition. All the platforms disclosed may be held in the hand of a user, or a caregiver, and resistively pulled or pushed with varied degrees of pressure over the skin proximate a specific part of the anatomy most in need of therapy or stimulation.

Proponents of natural and holistic healing methods have demonstrated that magnetic therapy can relieve pain caused by arthritis, injury, headaches, and stress. A directly-applied magnetic field can assist the healing of a broken bone. Many in the healing profession also believe that a magnetic field can increase blood circulation, alter nerve impulses, increase the flow of oxygen to body cells, decrease fatty deposits on artery walls, and realign thought patterns to improve emotional well-being.

Studies have shown that reflexology therapy applied to specific areas improved blood flow to that specific pan of the body, for instance, the kidneys, intestines, and the brain. For the foregoing reasons, magnetic balls, along with plastic balls, are used as essential components of the System disclosed.

### BRIEF DESCRIPTION OF THE VIEWS OF THE DRAWINGS

FIG. 1 illustrates a full perspective view of the preferred embodiment of the System 1, comprising a rectangular platform 14 having twenty-four non-rotating balls rigidly fixed within cavities 8 of the platform.

FIG. 2 depicts an overhead view of the top surface of the rectangular platform 24 with twenty-four vacant cavities.

FIG. 3 is a side view of the rectangular platform as seen from the section line 2-2.

FIG. 4 is an overhead view of the upper surface 2 of the rectangular platform embodiment, further showing treatment lanes and directions of movement 40, 41 of the device for therapeutic purposes.

FIG. 5 is a perspective view of small embodiment of the System 1.

FIG. 6 illustrates a cored ball 44.

FIG. 7 depicts the rod used to insert through the shafts of adjacent cored balls as a means of retention of the cored balls 44 within the cavities of a platform.

Table of Nomenclature & Part Numbers of Invention

| | |
|---|---|
| 1. | System |
| 2. | Upper surface |
| 3. | Undersurface |
| 4. | Front side |
| 5. | Rear side |
| 6. | Left side |
| 7. | Right side |
| 8. | Hemispherical cavity |
| 9. | Center |
| 10. | Diameter of cavity |
| 11. | Diameter of ball |
| 12. | Depth C |
| 13. | Circumference D |
| 14. | Rectangular platform |
| 15. | Square platform |
| 16. | Corner plate |
| 17.-19. | n/a |
| 20. | First line |
| 21. | Second line |
| 22. | Third line |
| 23. | Fourth line |
| 24. | Fifth line |
| 25. | Sixth line |
| 26. | Seventh line |
| 27.-29. | n/a |
| 30. | First lane |
| 31. | Second lane |
| 32. | Third lane |
| 33. | Fourth lane |
| 34. | Fifth lane |
| 35.-39. | n/a |
| 40. | First direction |
| 41. | Second direction |
| 42. | Plastic ball |
| 43. | Magnetic ball |
| 44. | Cored ball |
| 45. | Shaft |
| 46. | Rod |
| 47. | Adhesive |

### DETAILED DESCRIPTION OF THE INVENTIVE CONCEPT

The objects, features, and advantages of the concept presented in this application are more readily understood when referring to the accompanying drawings. The drawings, totaling seven figures, show the basic components and functions of embodiments and/or methods of use. In the several figures, like reference numbers are used in each figure to correspond to the same component as may be depicted in other figures.

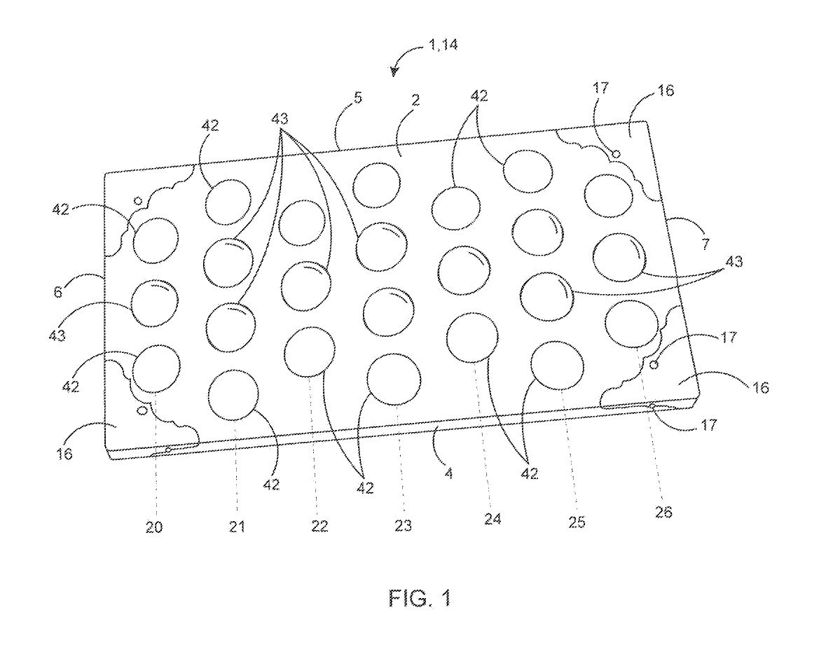

The discussion of the present inventive concept will be initiated with FIG. 1, which illustrates a top view of a System 1 constructed of a solid rectangular platform 14 having fourteen (14) plastic balls 42 and ten (10) magnetic balls 43 combined in a symmetrically-spaced pattern on the upper surface 2 of the rectangular platform 14. The rectangular platform 14 is the preferred embodiment of the System 1 and further comprises a left side 6, a right side 7, a front side 4, a rear side 5, an upper surface 2, and an undersurface 3 (not shown). Each of the four corners of the rectangular platform 14 is protected by a corner plate 16, each corner plate being held in position by at least three fasteners 17.

In FIG. 1, the symmetrical pattern of the balls 42, 43 is defined by several parallel lines, beginning with a first line 20 which shows two plastic balls 42 and a magnetic ball 43 grouped in alignment. A second line 21 depicts two plastic balls 42 and two magnetic balls 43 end a linear grouping of four. As can be seen, the remaining lines 22, 23, 24, 24, 25, and 26, display alternating groupings of three and four plastic and magnetic balls 42, 43, symmetrically dispersed as shown.

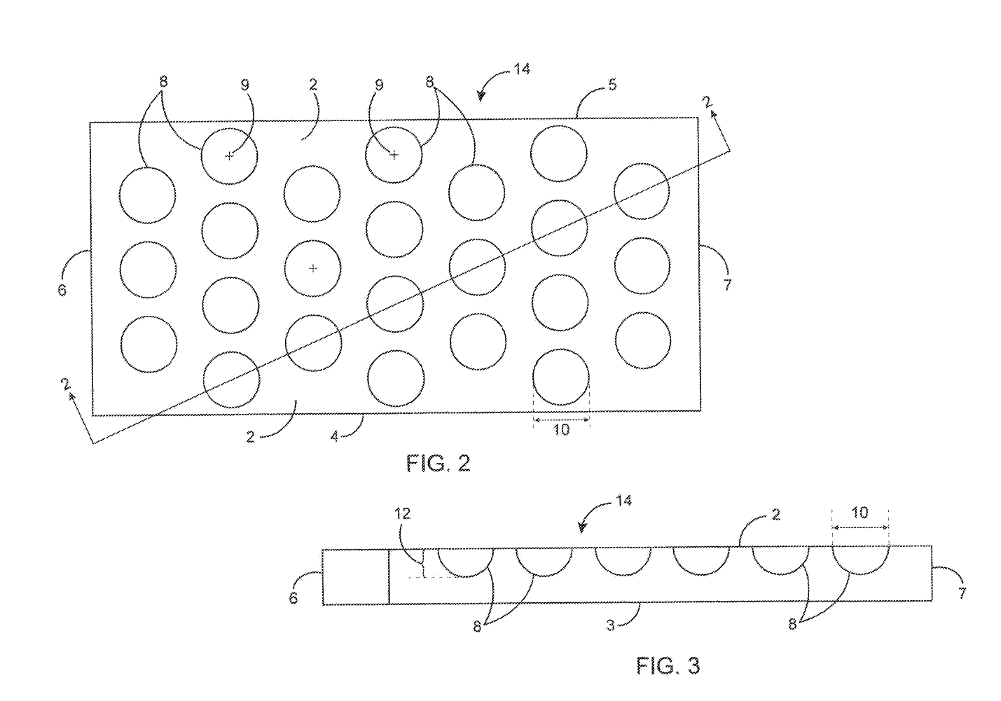

Referring to FIG. 2, there is illustrated a view of the top surface 2 of an unfinished rectangular platform 14. The rectangular platform 14 comprises a left side 6, a right side 7 a front side 4, a rear side 5, an upper surface 2 and an undersurface 3 (not shown). The rectangular platform 14 is shown with no balls 42, 43 having been inserted, thereby displaying twenty-four (24) cavities 8 which have been symmetrically machined into the top surface 2. Each of the cavities 8 shown comprises a certain diameter 10 and has a center point 9. The center point 9 of a cavity 8, when projected upward perpendicular to the top surface 2 of the rectangular platform 14, corresponds to the vertical axis of any ball 42, 43, that may be inserted into the cavity 8. The rectangular platform 14 shown in FIG. 2 may accommodate twenty-four (24) balls, either all fabricated from plastic, all magnetic, or any combination of plastic balls 42 and magnetic balls 43.

FIG. 3 illustrates a cross-sectional side view of the unfinished rectangular platform 14 of FIG. 2, as seen from the perspective of section line 2-2 of FIG. 2. As can be seen in FIG. 3, the left side 6, top surface 2, right side 7, and bottom surface 3, of the rectangular platform 14 are evident. Further, cutaway views of six (6) of the cavities 8 are also shown, along with a representative dimension depicting the approximate diameter 10 of each cavity 8. A dimension interval representing the depth 12 of each cavity 8 is also shown. The plastic and magnetic balls 42, 43 previously discussed comprise a diametric dimension 11 slightly larger than the diameter 10 of each of the cavities 8. Because of this dimensional difference, each ball 42, 43 must be placed into each individual cavity 8 by the exertion of a force exceeding twenty pounds per square inch (20 psi). The elastomeric qualities of the rectangular platform 14 exert a physical tension such that each loaded cavity 8 exerts a continuous sidewise grip onto the surface of each ball 42, 43 parallel to the upper surface 2 of the platform 14.

A user or caregiver may operate the System 1 in treating parts of the anatomy for full body therapeutics by (a) while sitting, standing, or lying, grasping the System 1 by any two of its sides 4, 5, 6, or 7 with one or two hands; (b) placing the System 1 on the intended area of the body with as many as possible of the stationary balls 42, 43 contacting that area; (c) sliding the System 1 along the skin, using comfortable pressure, and with any chosen pattern. If necessary, the person being treated may get assistance from another person or a caregiver and repeat the above steps.

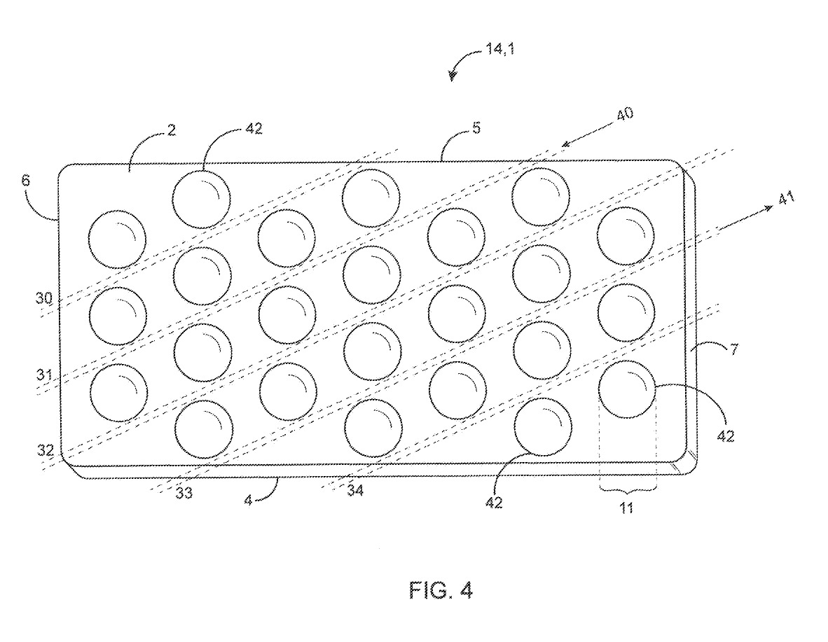

FIG. 4 illustrates a view of the top surface 2 of a System 1 in the form of a rectangular platform 14 having twenty-four plastic balls 42 inserted into twenty-four cavities (hidden from view). The displayed System 1 comprises a left side 6, a right side 7, a front side 4, a rear side 5, an upper surface 2 and an undersurface 3 (not visible). The pattern of the balls 42 shown corresponds to the construction of the cavities 8 previously discussed. Each of the balls 42, 43 comprises a certain diameter 11 which may be equal to, or slightly larger than the diameter 10 of the cavities 8 previously discussed.

The arrangement of the balls 42 in FIG. 4 further creates a naturally occurring pattern of five “lanes.” A first lane 30 is shown extending diagonally from left to right proximate the upper left corner of the System 1. A second lane 31 is depicted adjacent to and parallel to the first lane 30. In a similar manner, a third lane 32, a fourth lane 33, and a fifth lane 34 are created. The lanes 31-33 provide the means for a user of the System 1 to treat oblong areas of the anatomy such as the outer edges of the palms, the soles of the feet, the wrists, and the forearm areas. This is accomplished by moving the body part in either diagonal direction 40 or direction 41 along any of the lanes 31-33.

A different embodiment of the inventive concept consists of two identical two rectangular platforms 14 having twenty-four plastic balls 42 inserted into the twenty-four cavities 8 existing in each of the two rectangular platforms 14. Each of said platforms 14 is attached, along an edge of its longest edge, 4, 5, to a hinged mechanism extending along the entirety of the connected edges, 4, 5, thereby allowing the first and second platforms to be hingedly affixed to each other, such that when opening said hinge, the upper surfaces of both of said platforms 14 lie in the same plane.

A user or caregiver may operate the System 1 to accomplish the therapeutic healing of the feet by (a) sitting on a surface such as a chair or couch with the legs forming a ninety degree angle at the knees; (b) for optimum results, placing a sock on each foot; (c) placing the System 1 on the floor length-wise with the stationary balls 42, 43 facing upward adjacent to one of the feet; (d) placing the selected foot on the surfaces of the stationary balls 42, 43; (e) sliding the sole of the foot back and forth over the surfaces of the stationary balls 42, 43. Additional therapy of the feet may be had by repeating the sliding motion for the outer edges of the soles of the feet along the longer diagonal lanes 31, 32, and 33 of the System 1.

For therapeutic treatment of a patient's hands, an optimum method is rendered by (a) sitting on a surface such as a chair, couch or bed with legs forming a ninety degree angle at the knees; (b) placing the System 1 across the lap with the stationary balls 42, 43 facing upward; (c) placing one or two hands with open palms over the surfaces of those stationary balls 42, 43 which underlie the area of the hand; (d) sliding the hand(s) over the surface of the stationary balls 42, 43 using a selected pattern of choice. Additional therapy for the hands may be accomplished by sliding the outer edge of the hands along the diagonal lanes 31, 32, 33 of the System 1. For each of the treatments described above, the user determines his or her own pace and also the total time of usage.

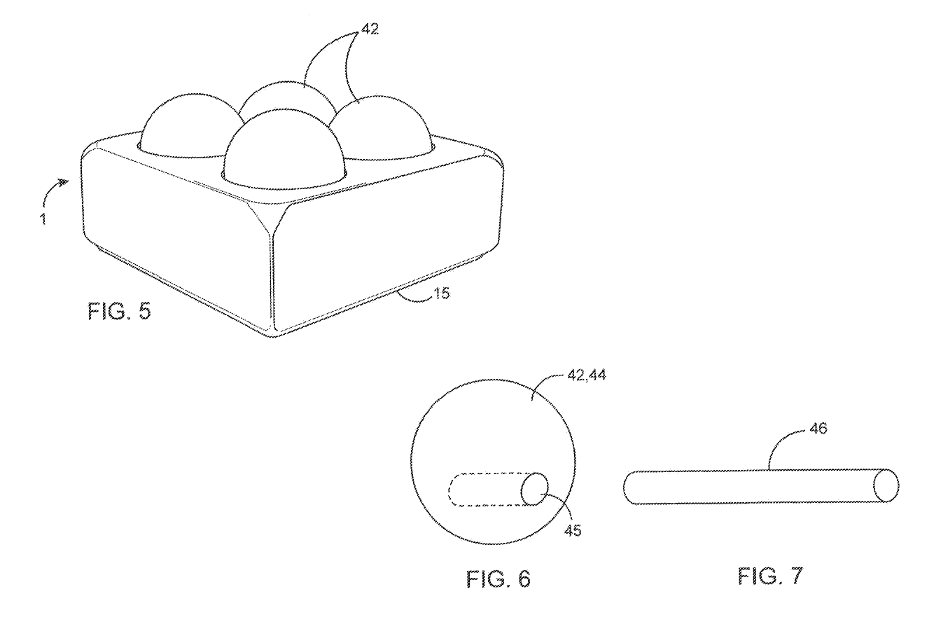

An additional embodiment of the System 1 is illustrated in FIG. 5 where there is shown a smaller version utilizing a square-shaped platform 15 containing four plastic balls 42. FIG. 6 displays the components which comprise an alternative method of retaining the balls 42, 43 in a platform 14, 15. Shown is a “cored” plastic ball 42, 44 formed by having a shaft 45 drilled through a hemispherical section of the cored ball 44. Also shown, in FIG. 7, is a length of rod 46 having a diameter corresponding to the inner diameter of the shalt 45 and a length approximately corresponding to the shortest width of a selected platform 14.

Using these components, the balls 42 of a System 1 may comprise cored balls 44 wherein adjacent balls of a line are arranged such that the shafts 45 of these balls 44 may accommodate an appropriate length of rod 46 through the shafts 45 and affixed to the innards of the platform 14. It is also necessary to drill a hole running linearly through adjacent cavities 8 which form the line(s) of those balls 44 connected in this manner.

While preferred embodiments of the present inventive concept have been shown and disclosed herein, it will be obvious to those persons skilled in the art that numerous variations, changes, and substitutions may occur to, or be suggested without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and is by no means limited by the wording of the claims presented herein.

What is claimed is:

1. A device for the purpose of therapeutic massage, magnetic therapy, and reflexology treatment of ailing segments of a human body, comprising:
a solid, elastomeric platform having an upper surface, an undersurface, and at least one side surface which is continuously connected to the edges of the upper surface and the undersurface;
a number of symmetrically-spaced hemispherical cavities of a certain depth and a certain diameter, as measured parallel to the upper surface, machined onto the upper surface; and
an equal number of spherical balls, each having a diameter approximately equivalent to the diameter of said cavities; wherein
each of said balls is, subsequent to the application of a liquid adhesive to the interior of a selected cavity, placed directly above the cavity and, by means of a force applied to the surface of said ball perpendicularly to the upper surface of said platform, forced into a fixed, non-rotating retention within the subject cavity.

2. The device of claim 1, wherein the spherical balls comprise a plastic material.

3. The device of claim 1, wherein the spherical balls comprise a certain number of balls comprising a plastic material and a certain number of balls comprising a magnetic material, both types of balls dispersed into said cavities in a symmetrically-spaced manner.

4. A device for the purpose of therapeutic massage, magnetic therapy, and reflexology treatment of ailing segments of a human body, comprising:
a solid, elastomeric, rectangular platform having an upper surface, an undersurface, a front side, a rear side, a left side, and a right side;
twenty-four (24) symmetrically-arranged hemispherical cavities of a certain depth and a certain diameter, as measured parallel to the upper surface, each cavity being machined onto the upper surface;
said symmetrical arrangement of the cavities consists of seven virtual parallel lines, parallel to the left side and right sides of said platform in which the centers of three cavities are aligned along the first parallel line, the centers of four cavities are aligned along the second parallel line, the centers of three cavities are aligned along the third parallel line, the centers of four cavities are aligned along the fourth parallel line the centers of three cavities are aligned along the fifth parallel line, the centers of four cavities are aligned along the sixth parallel line, and the centers of three cavities are aligned along the seventh parallel line, the arrangement further creating a diagonal alignment of the cavities from left to right and from right to left on the upper surface; and
twenty-four (24) spherical balls, each having a diameter approximately equivalent to the diameter of said cavities; wherein
each of said balls is, subsequent to the application of a liquid adhesive to the interior of a selected cavity, placed directly above the cavity and, by means of a force applied to the surface of said ball perpendicularly to the upper surface of said platform, forced into a fixed, non-rotating retention within the subject cavity.

5. The device of claim 4, wherein the spherical balls comprise a plastic material.

6. The device of claim 4, wherein the spherical balls comprise ten (10) balls of a magnetic material affixed substantially within the ten interior cavities of the platform and fourteen (14) balls of a plastic material affixed substantially within the fourteen exterior cavities along the front and rear sides of the platform.

7. The device of claim 1, wherein the balls are retained in said platform by means of a lineal rod of a certain diameter and a certain length inserted into a shaft of an interior diameter corresponding to the diameter of said rod, said shaft having been priorly drilled through one hemisphere of each ball, and further, a corresponding shaft having been drilled through cavities lying within the same line, wherein a rod is inserted through said balls and cavities lying within the same line and thereupon said rod being fixed interiorly to the platform.

8. The device of claim 4, wherein the balls are retained in said platform by means of a lineal rod of a certain diameter and a certain length inserted into a shaft of an interior diameter corresponding to the diameter of said rod, said shaft having been priorly drilled through one hemisphere of each ball, and further, a corresponding shaft having been drilled through cavities lying within the same line, wherein the rod is inserted through said balls and cavities lying within the same line and thereupon said rod being fixed interiorly to the platform.

9. A device for the purpose of therapeutic massage, magnetic therapy, and reflexology treatment of ailing segments of a human body, comprising:
a first solid, elastomeric, rectangular platform having an upper surface, an undersurface, a front side, a rear side, a left side, and a right side; and a second solid, elastomeric, rectangular platform having an upper surface, an undersurface, a front side, a rear side, a left side, and a right side;
twenty-four (24) symmetrically-arranged hemispherical cavities of a certain depth and a certain diameter, as measured parallel to the upper surface of each of said first and second platforms, each cavity being machined onto the upper surface;
a specific symmetrical arrangement of the cavities of each of said first and second platforms consisting of seven virtual parallel lines, parallel to the left side and right sides of said platforms in which the centers of three cavities are aligned along the first parallel line, the centers of four cavities are aligned along the second parallel line, the centers of three cavities are aligned along the third parallel line, the centers of four cavities are aligned along the fourth parallel line, the centers of three cavities are aligned along the fifth parallel line, the centers of four cavities are aligned along the sixth parallel line, and the centers of three cavities are aligned along the seventh parallel line, the arrangement further creating a diagonal alignment of the cavities from left to right and from right to left on the upper surface of each of said platforms;
two sets of twenty-four (24) spherical balls, each having a diameter approximately equivalent to the diameter of said cavities; wherein
one set of said balls is, subsequent to the application of a liquid adhesive to the interior of a selected cavity, placed directly above a cavity and, by means of pressure applied to the surface of said ball perpendicularly to the upper surface of each of said platforms, forced into a fixed, non-rotating retention within the subject cavity; and further,
each of said platforms is attached, along an edge of its longest length, to a continuous hinged mechanism extending along the entirety of the connected edges, thereby allowing the first and second platforms to be hingedly affixed to each other, such that when opening said hinge, the upper surfaces of both of said platforms lie adjacent to each other in the same plane.

10. The device of claim 9, wherein the spherical balls comprise a plastic material.

11. The device of claim 9, wherein the spherical balls comprise ten (10) balls of a magnetic material affixed substantially within the ten interior cavities of each of the first and second platforms and fourteen (14) balls of a plastic material affixed substantially within the fourteen exterior cavities along the front and rear sides of each of said first and second platforms.
